(19) United States
(12) Patent Application Publication
(10) Pub. No.: US 2025/0264175 A1
(43) Pub. Date: Aug. 21, 2025

(54) LOCK OUT TAG OUT FOR QUICK DISCONNECT

(71) Applicant: Barnes Group, Bristol, CT (US)

(72) Inventors: Michael Pompa, Cuyahoga Falls, OH (US); Evan Nelson, Parma, OH (US)

(21) Appl. No.: 19/053,820

(22) Filed: Feb. 14, 2025

Related U.S. Application Data
(60) Provisional application No. 63/554,442, filed on Feb. 16, 2024.

(51) Int. Cl. F16L 37/16

(52) U.S. Cl. CPC F16L 37/16; F16L 2201/20

(57) ABSTRACT

A lockout tagout device associated with a fitting includes a body having a first body portion and a second body portion. The second body portion is movable relative to the first body portion about an axis of rotation to transform the body between a closed configuration and an open configuration. The lockout tagout device is connectable to the fitting such that the axis of rotation is oriented parallel to a longitudinal axis of the fitting.

### CROSS-REFERENCE TO RELATED APPLICATIONS

This application claims the benefit of U.S. Application No. 63/554,442, filed Feb. 16, 2024, the contents of which are incorporated by reference herein in their entirety.

### BACKGROUND

Embodiments of the present disclosure relate to a lockout tagout device, and more particularly, to a lockout tagout device suitable for use with a quick connector coupling.

Lockout tagout devices may be used in a variety of applications to lock out access to a component of a machine, such as during maintenance for example, to prevent a release of pneumatic, thermal, or chemical energy. Once a lockout tagout device is installed, a warning tag may be used to indicate that the system and the isolating component may not be operated until the tag is removed and the component is unlocked.

Some existing lockout tagout devices have various shortcomings making them unsuitable for use in one or more applications. For example, a control panel of a fluid system may be crowded thereby limiting the available space for lockout tagout device to couple to a quick connector coupling of the control panel. Accordingly, it is desirable to design a lockout tagout device having a reduced sizing envelope for use in confined spaces.

### BRIEF DESCRIPTION

According to an embodiment, a lockout tagout device associated with a fitting includes a body having a first body portion and a second body portion. The second body portion is movable relative to the first body portion about an axis of rotation to transform the body between a closed configuration and an open configuration. The lockout tagout device is connectable to the fitting such that the axis of rotation is oriented parallel to a longitudinal axis of the fitting.

In addition to one or more of the features described above, or as an alternative to any of the foregoing embodiments the body has a first end, a second end, a sidewall extending between the first end and the second end, and an internal cavity. The first end has an opening for receiving the fitting formed therein.

In addition to one or more of the features described above, or as an alternative to any of the foregoing embodiments each of the first body portion and the second body portion, respectively, defines part of the first end, the second end, and the sidewall.

In addition to one or more of the features described above, or as an alternative to any of the foregoing embodiments an end of the fitting is receivable within the internal cavity and a diameter of the opening is smaller than a diameter of the end of the fitting receivable within the internal cavity.

In addition to one or more of the features described above, or as an alternative to any of the foregoing embodiments the internal cavity includes a sloped surface positionable in contact with a fitting surface to form a seal between the body and the fitting.

In addition to one or more of the features described above, or as an alternative to any of the foregoing embodiments the sloped surface is complementary to the fitting surface.

In addition to one or more of the features described above, or as an alternative to any of the foregoing embodiments the first body portion includes a first locking hole and the second body portion includes a second locking hole. The first locking hole is arranged at a non-parallel angle to the second locking hole when the body is in the open configuration. The first locking hole is aligned with the second locking hole when the body is in the closed configuration.

In addition to one or more of the features described above, or as an alternative to any of the foregoing embodiments the first body portion includes a first locking flange extending from the second end of the body and the second body portion includes a second locking flange extending from the second end of the body. The first locking hole is formed in the first locking flange and the second locking hole being formed in the second locking flange.

In addition to one or more of the features described above, or as an alternative to any of the foregoing embodiments the first locking flange has a first contoured surface and the second locking flange has a second contoured surface. The first contoured surface is complementary to the second contoured surface.

In addition to one or more of the features described above, or as an alternative to any of the foregoing embodiments the first body portion includes a first engagement member and the second body portion includes a second engagement member. The first engagement member is arranged in contact with the second engagement member when the body is in the closed configuration.

In addition to one or more of the features described above, or as an alternative to any of the foregoing embodiments the second engagement member protrudes radially outwardly beyond the sidewall.

In addition to one or more of the features described above, or as an alternative to any of the foregoing embodiments the body includes a tether arm having an opening, the opening being arranged parallel to the axis of rotation.

In addition to one or more of the features described above, or as an alternative to any of the foregoing embodiments the body is formed from a non-metallic material.

According to an embodiment, a lockout tagout assembly includes a fitting, a lockout tagout device connectable to the fitting and including a body having a first body portion and a second body portion. The second body portion is movable relative to the first body portion to transform the body between a closed configuration and an open configuration. A portion of the body is positionable in contact with the fitting and the portion of the body that is positionable in contact with the fitting is not formed from a metal material.

In addition to one or more of the features described above, or as an alternative to any of the foregoing embodiments the body includes a first end, a second end, a sidewall extending between the first end and the second end, and an internal cavity. The internal cavity is not formed from the metal material.

In addition to one or more of the features described above, or as an alternative to any of the foregoing embodiments the first end includes an opening and the fitting is positionable within the opening such that an end of the fitting is arranged within the internal cavity.

In addition to one or more of the features described above, or as an alternative to any of the foregoing embodiments a diameter of the opening is smaller than a diameter of a portion of the fitting receivable within the internal cavity.

In addition to one or more of the features described above, or as an alternative to any of the foregoing embodiments the internal cavity includes a sloped surface being positionable in contact with a fitting surface to form a seal between the body and the fitting.

In addition to one or more of the features described above, or as an alternative to any of the foregoing embodiments the sloped surface is complementary to the fitting surface.

In addition to one or more of the features described above, or as an alternative to any of the foregoing embodiments the second body portion is movable relative to the first body portion about an axis of rotation and the axis of rotation is oriented parallel to a longitudinal axis of the fitting.

### BRIEF DESCRIPTION OF THE DRAWINGS

The following descriptions should not be considered limiting in any way. With reference to the accompanying drawings, like elements are numbered alike:

FIG. 1 is a perspective view of a lockout tagout device in an open configuration according to an embodiment;

FIG. 2 is a perspective view of a lockout tagout device in a closed configuration according to an embodiment;

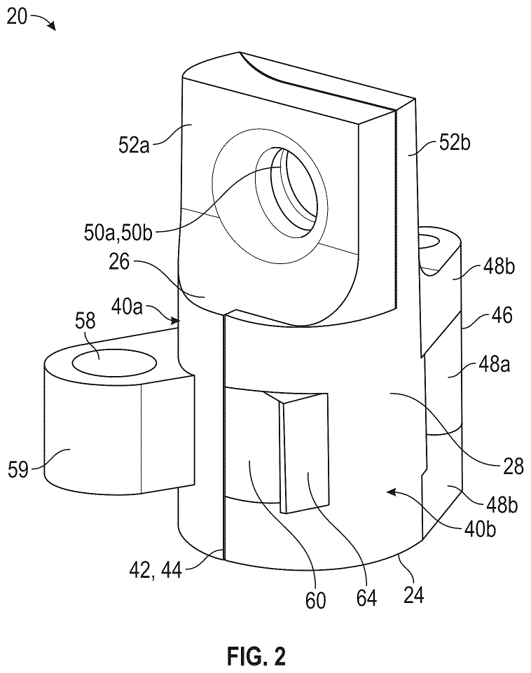

FIGS. 3A and 3B are various views of a lockout tagout device in an open configuration and positioned about a fitting according to an embodiment;

FIGS. 4A and 4B are various views of the lockout tagout device of FIGS. 3A and 3B in a closed configuration about the fitting according to an embodiment; and

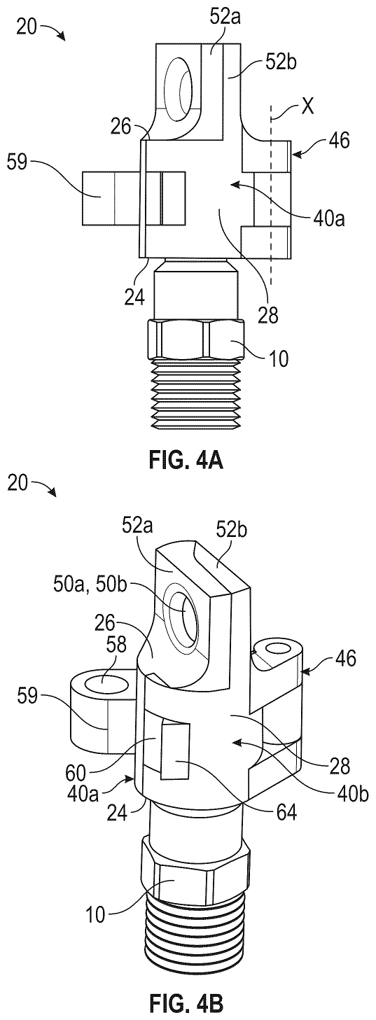

FIG. 5 is a detailed cross-sectional view of an interface between the lockout tagout device and a fitting according to an embodiment.

### DETAILED DESCRIPTION

A detailed description of one or more embodiments of the disclosed apparatus and method are presented herein by way of exemplification and not limitation with reference to the Figures.

With reference now to the FIGS., an example of a lockout tagout device 20 is illustrated. As shown, the lockout tagout device 20 includes a body 22 transformable between an open configuration and a closed configuration. The body 22 is couplable to a fitting 10, such as a male quick disconnect for example. As will be described in more detail below, the lockout tagout device 20 may be positionable about a distal end 12 of the fitting 10.

The body 22 of the lockout tagout device 20 may be formed from any suitable material, including, but not limited to a plastic or a composite material for example. In an embodiment, the body 22 is formed from a non-metallic material. However, in some embodiments, only a portion of the body may be formed from a non-metallic material. For example, any portion of the body 22 configured to contact the fitting 10 is formed from a non-metallic material to prevent metal on metal contact. Further, the lockout tagout device 20 may be formed via any suitable manufacturing process including but not limited to injection molding or additive manufacturing.

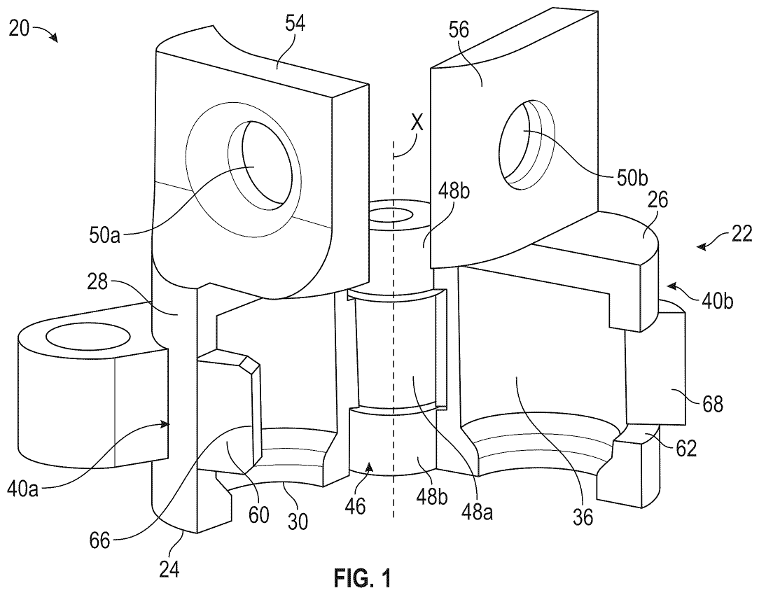

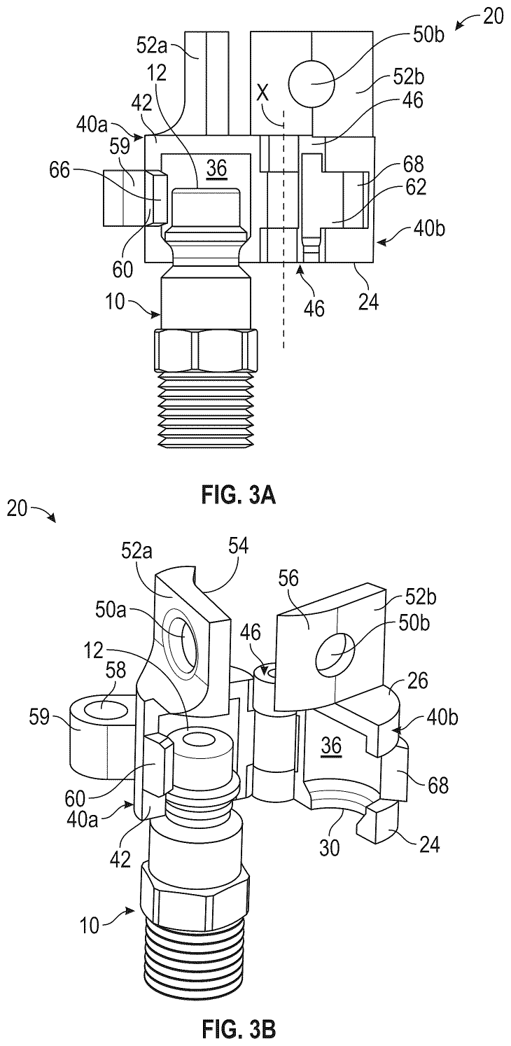

In the illustrated, non-limiting embodiment, when the lockout tagout device 20 is in the closed configuration, the body 22 is generally cylindrical in shape. However, embodiments where the body 22 has another shape are also within the scope of the disclosure. The body 22 includes a first end 24, a second end 26, and at least one sidewall 28 extending between and connecting the first end 24 and the second end 26. As best shown in FIGS. 1, 3A, and 3B, the first end 24 may include an opening 30 within which a portion of the fitting 10 is receivable and the second, opposite end 26 of the body 22 may be substantially closed or sealed.

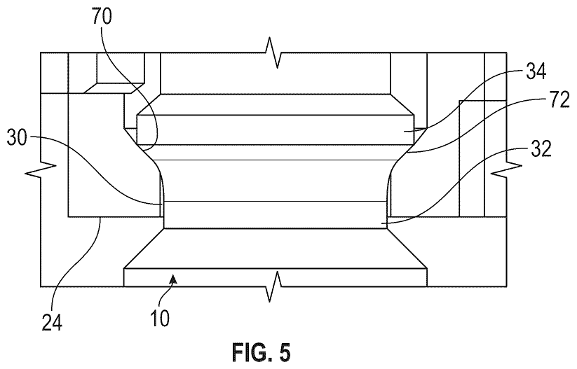

With reference to FIGS. 3A, 3B, and 5, the diameter of the opening 30 formed in the first end 24 of the body 22 is generally equal to or larger than a diameter of the fitting 10 at a first location, illustrated at 32 (see FIG. 5). In an embodiment, the diameter of the opening 30 may also be smaller than the diameter of the fitting 10 at a second location, illustrated at 34, such as a flange for example. The second location 34 may be positioned near or adjacent to the first location 32. In some embodiments, the second location 34 is positioned between the first location 32 and the distal end 12 of the fitting 10. As a result, the enlarged diameter at the second location 34 restricts relative movement between the body 22 and the fitting 10 in one or more axial directions. For example, the enlarged diameter of the fitting 10 at the second location 34 may restrict separation of the fitting 10 from the body 22 of the lockout tagout device 20.

In an embodiment, a cavity 36 is formed within the interior of the body 22 and is configured to receive a portion of the fitting 10, such as the distal end 12 for example, therein. Accordingly, the overall size of the cavity 36 must be equal to or larger than the portion of the fitting extending between the first location 32 and the distal end 12. The cavity 36 may but need not have a shape complementary or similar to the shape of the exterior of the body 22. Alternatively, or in addition, the cavity 36 may but need not have a shape complementary or similar to the shape of the end 12 of the fitting 10 to which the lockout tagout device 20 is connectable. The cavity 36 may extend over only a portion of the axial length of the body 22, or alternatively, may extend generally from the first end 24 to the second end 26 such that the substantial entirety of the interior of the body 22 is hollow.

The body 22 may be defined by a plurality of body portions connectable to one another to affix the lockout tagout device 20 to the fitting 10. In the illustrated, non-limiting embodiment, the body 22 includes a first body portion 40a and a second body portion 40b; however, embodiments having more than two portions are also within the scope of the disclosure. As shown, the first end 24, the second end 26, and the sidewall 28 extending therebetween may be formed, in combination, by the first body portion 40a and the second body portion 40b. In an embodiment, the portion of the first end 24, the second end 26, and the sidewall 28 formed by the first body portion 40a are generally symmetrical with the portion of the first end 24, the second end 26, and the sidewall 28 formed by the second body portion 40b. However, in other embodiments, the breakdown or division of the body 22 between the first and second body portions 40a, 40b may be uneven. For example, the first body portion 40a may define more than 180 degrees of the periphery of the body 22 and the second body portion 40b may define less than 180 degrees of the periphery of the body 22 or vice versa.

The first body portion 40a may have a first planar surface 42 and the second body portion 40b may have a second planar surface 44. In an embodiment, the first and second planar surfaces 42, 44 may be configured to contact one another when the lockout tagout device 20 is in a closed configuration. Accordingly, the first and second planar surfaces 42, 44, may define a plane along which the body 22 is divided into the first body portion 40a and the second body portion 40b, respectively. Further, the first and second planar surfaces 42, 44 may be spaced from one another when the lockout tagout device 20 is in an open configuration.

In the illustrated, non-limiting embodiment, the first body portion 40a and the second body portion 40b remain connected to one another when the lockout tagout device 20 is in both an open configuration and a closed configuration. As shown, the first body portion 40a and the second body portion 40b may be rotatably coupled to one another. However, embodiments where the first body portion 40a is completely separated from the second body portion 40b when the lockout tagout device 20 is in an open configuration are also within the scope of the disclosure.

In the illustrated, non-limiting embodiment, the first body portion 40a is connected to the second body portion 40b via a hinge, illustrated generally at 46. Accordingly, the first body portion 40a is rotatable relative to the second body portion about an axis of rotation X of the hinge 46. The hinge 46 may be arranged at an exterior of the body 22, such as at an outer periphery thereof. In such embodiments, the rotational axis X of the hinge 46 may be spaced or laterally offset from the periphery of the fitting 10 when the lockout tagout device 20 is connected to the fitting 10.

In an embodiment, the axis X of the hinge 46 is oriented substantially parallel to the longitudinal axis of the fitting 10. However, embodiments where the axis X is arranged at a non-zero angle relative to the longitudinal axis of the fitting 10 are also contemplated herein. In embodiments including a hinge 46, each of the first body portion 40a and the second body portion 40b may include one or more barrels rotatably mounted about a pin (not shown) defining the axis X. The at least one barrel 48a of the first body portion 40a and the at least one barrel 48b of the second body portion 40b may be stacked in an alternating configuration along the axial length of the pin. In an embodiment, the diameter for receiving the pin formed in the outermost barrels of the hinge 46 may be smaller than the diameter for receiving the pin formed in the central barrels of the hinge 46. This combination of diameters may create a tight or slip fit type of connection with the pin.

The body 22 includes a plurality of aligned locking holes when the lockout tagout device 20 is in a closed configuration. In such a configuration, a shackle or shank of a lock (not shown) is extendable through the plurality of locking holes to prevent the body 22 from transforming to the open configuration. In the illustrated, non-limiting embodiment, a first locking hole 50a is associated with the first body portion 40a and a second locking hole 50b is associated with the second locking portion 40b. Although the first and second locking holes 50a, 50b are illustrated as being substantially identical, in other embodiments, the first locking hole 50a may be a different size and/or shape from the second locking hole 50b.

The first and second locking holes 50a, 50b may be arranged at any suitable location about the lockout tagout device 20. In an embodiment, the first body portion 40a includes a first locking flange 52a extending from the second end 26 of the body 22. The first locking flange 52a may extend at a non-parallel angle relative to the second end 26 of the body 22, such as parallel to the longitudinal axis of the body 22 or the fitting 10, or to the axis X of the hinge 46 for example. In some embodiments, a first locking hole 50a may be formed in the first locking flange 52a. Similarly, a second locking flange 52b may extend at an angle from the second end 26 of the body 22 and a second locking hole 50b may be formed in the second locking flange 52b. In the illustrated, non-limiting embodiment, one or both of the first and second locking flanges 52a, 52b and/or the first and second locking holes 50a, 50b is oriented substantially perpendicular to the planar surface 42, 44 of the first and second body portion 40a, 40b, respectively. However, embodiments including a locking flange having another configuration are also within the scope of the disclosure.

When the body 22 is in the open configuration, the first and second locking flanges 52a, 52b may be arranged at a non-parallel angle relative to one another. As a result, the first and second locking holes 50a, 50b are not aligned or coaxial. As the first and second body portions 40a, 40b are moved relative to one another toward the closed configuration, the first and second locking flanges 52a, 52b move relative to one another to align the first and second locking holes 50a, 50b. In some embodiments, the first and second locking flanges 52a, 52b are not only parallel to one another, but also are arranged in contact with one another when the lockout tagout device 20 is in the closed configuration. In such embodiments, a surface 54 of the first locking flange 52a may be complementary to the adjacent surface 56 of the second locking flange 52b. While these surfaces 54, 56 may have a generally planar configuration, in other embodiments, these surfaces 54, 56 may be contoured. In the non-limiting embodiment illustrated in the FIGS., each of the contoured surfaces 54, 56 has a curvature formed therein and when the lockout tagout device 20 is in the closed configuration, the curved surfaces 54, 56 are flush against one another. Inclusion of such a curvature may prevent the lockout tagout device 20 from binding as it transforms to the closed configuration.

The lockout tagout device 20 may additionally include an opening 58 for receiving a lanyard therein. In the illustrated, non-limiting embodiment, a tether arm 59 protrudes radially outwardly from the sidewall 28 of the body 22. Although the tether arm 59 is illustrated as being arranged at the first body portion 40a, it should be understood that in other embodiments a tether arm 59 may be alternatively or additionally be arranged at the second body portion 40b. The tether arm 59 may be oriented such that the opening 58 formed therein extends generally parallel to at least one of the longitudinal axis of the fitting 10 and the rotational axis X of the hinge 46.

In an embodiment, a first engagement member 60, such as a tab for example, extends from the surface 42 of the first body portion 40a. A corresponding recess 62 may be formed in the second body portion 40b. Further, a second engagement member 64, such as a tooth for example, may protrude radially outwardly from the second body portion 40b at an edge of the recess 62. When the lockout tagout device 20 is in the closed configuration, the first engagement member 60 may be arranged in contact with the second engagement member 64. For example, an end 66 of the first engagement member 60 may abut against a surface 68 (FIG. 1) of the second engagement member 64. The surface 68 of the second engagement member 64 may be arranged at a non-zero angle relative to the surface 44 of the second body portion 40b and to the end 66 of the first engagement member 60. This engagement between the first engagement member 60 and the second engagement member 64 may assist in retaining the body 22 in the closed configuration. Further, by having the second engagement member 64 protrude beyond the exterior surface of the sidewall 28, the second engagement member 64 may provide a contact point for a user, allowing the lockout tagout device 20 to be opened. It should be understood that although the first engagement member 60 is illustrated and described herein as being associated with the first body portion 40a, in other embodiments, a first engagement member 60 may be associated with the second body portion 40b and a recess 62 and second engagement member 64 may be associated with the first body portion 40a.

When the lockout tagout device 20 is in the closed configuration about a fitting 10, the lockout tagout device 20 may form a seal with the fitting 10. With reference now to FIG. 5, the interface between the first end 24 of the body 22 and the fitting 10 is illustrated in more detail. As shown, an interior surface of the cavity 36 at a location adjacent to the opening 30 may include a sloped surface 70. The sloped surface 70 may be configured to contact or engage a corresponding surface of the fitting 10, such as to restrict separation of the fitting 10 from the lockout tagout device 20. The angle of the surface 70 may control the contact area between the body 22 and the fitting 10. A surface of the fitting 10, also referred to herein as a fitting surface, may alternatively or additionally be tapered or sloped. The fitting surface 72 may be arranged between the first location 32 and the second location 34 of the fitting 10, such as directly adjacent to the second location 34 for example. In such embodiments, the slope or angle of the surface 70 of the body 22 may be generally equal to the slope or angle of the corresponding fitting surface 72, such as within ±2 degrees for example. In an embodiment, the surface 70 is arranged at a 45-degree angle relative to a longitudinal axis of the body 22. However, embodiments where the angles of the surfaces 70, 72 are different are also contemplated herein.

In operation, a user will position a lockout tagout device 20 in an open configuration about the fitting. As shown, the fitting 10 will be positioned with the flange or second location 34 of the fitting arranged within the cavity 36 and the first location 32 at the opening 30 formed in the first end 24 of the first body portion 40a. A user will then rotate the second body portion 40a about the axis X of the hinge 46 toward the first body portion 40a until reaching a closed configuration. In the closed configuration, the surfaces 42, 44 of the first and second body portions 40a, 40b abut one another, the first and second locking flanges 52a, 52b abut one another, and/or the end 66 of the first engagement member 60 is in contact with the surface 68 of the second engagement member 64. It should be understood that a user can easily insert the fitting 10 and transform the lockout tagout device to a closed configuration using one hand. Once in the closed configuration, a lock may be inserted through the aligned locking holes 50a, 50b to retain the lockout tagout device 20 in the closed configuration coupled to the fitting 10.

A lockout tagout device 20 as illustrated and described herein has a confined size suitable for use in applications with limited space surrounding the component that the lockout tagout device 20. The lockout tagout device 20 additionally does not allow metal to metal contact with the fitting 10. A portion of the body positionable in contact with the fitting, such as the internal cavity 36 or a surface thereof, the sloped surface 70, and/or the surface defining the opening 30 formed in the body 22 for example, are not formed from a metal material. Further, the lockout tagout device 20 complies with all relevant OSHA standards, such as OSHA 29 CFR 1910.147, relative to the control of energy sources.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A lockout tagout device associated with a fitting comprising:
a body, the body having a first body portion and a second body portion, the second body portion being movable relative to the first body portion about an axis of rotation to transform the body between a closed configuration and an open configuration; and
wherein the lockout tagout device is connectable to the fitting such that the axis of rotation is oriented parallel to a longitudinal axis of the fitting.

2. The lockout tagout device of claim 1, wherein the body has a first end, a second end, a sidewall extending between the first end and the second end, and an internal cavity, the first end having an opening for receiving the fitting formed therein.

3. The lockout tagout device of claim 2, wherein each of the first body portion and the second body portion, respectively, defines part of the first end, the second end, and the sidewall.

4. The lockout tagout device of claim 2, wherein an end of the fitting is receivable within the internal cavity and a diameter of the opening is smaller than a diameter of the end of the fitting receivable within the internal cavity.

5. The lockout tagout device of claim 2, wherein the internal cavity includes a sloped surface, the sloped surface being positionable in contact with a fitting surface to form a seal between the body and the fitting.

6. The lockout tagout device of claim 5, wherein the sloped surface is complementary to the fitting surface.

7. The lockout tagout device of claim 2, wherein the first body portion includes a first locking hole and the second body portion includes a second locking hole, the first locking hole being arranged at a non-parallel angle to the second locking hole when the body is in the open configuration, and the first locking hole being aligned with the second locking hole when the body is in the closed configuration.

8. The lockout tagout device of claim 7, wherein the first body portion includes a first locking flange extending from the second end of the body and the second body portion includes a second locking flange extending from the second end of the body, the first locking hole being formed in the first locking flange and the second locking hole being formed in the second locking flange.

9. The lockout tagout device of claim 8, wherein the first locking flange has a first contoured surface and the second locking flange has a second contoured surface, the first contoured surface being complementary to the second contoured surface.

10. The lockout tagout device of claim 2, wherein the first body portion includes a first engagement member and the second body portion includes a second engagement member, the first engagement member being arranged in contact with the second engagement member when the body is in the closed configuration.

11. The lockout tagout device of claim 10, wherein the second engagement member protrudes radially outwardly beyond the sidewall.

12. The lockout tagout device of claim 1, wherein the body further comprises a tether arm having an opening, the opening being arranged parallel to the axis of rotation.

13. The lockout tagout device of claim 1, wherein the body is formed from a non-metallic material.

14. A lockout tagout assembly comprising:
a fitting;
a lockout tagout device connectable to the fitting, the lockout tagout device including a body, the body having a first body portion and a second body portion, the second body portion being movable relative to the first body portion to transform the body between a closed configuration and an open configuration; and
wherein a portion of the body is positionable in contact with the fitting and the portion of the body that is positionable in contact with the fitting is not formed from a metal material.

15. The lockout tagout assembly of claim 14, wherein the body further comprises a first end, a second end, a sidewall extending between the first end and the second end, and an internal cavity, wherein the internal cavity is not formed from the metal material.

16. The lockout tagout assembly of claim 15, wherein the first end includes an opening, and the fitting is positionable within the opening such that an end of the fitting is arranged within the internal cavity.

17. The lockout tagout assembly of claim 16, wherein a diameter of the opening is smaller than a diameter of a portion of the fitting receivable within the internal cavity.

18. The lockout tagout assembly of claim 15, wherein the internal cavity includes a sloped surface, the sloped surface being positionable in contact with a fitting surface to form a seal between the body and the fitting.

19. The lockout tagout assembly of claim 18, wherein the sloped surface is complementary to the fitting surface.

20. The lockout tagout assembly of claim 14, wherein the second body portion is movable relative to the first body portion about an axis of rotation and the axis of rotation is oriented parallel to a longitudinal axis of the fitting.
